(19) United States
(12) Patent Application Publication
(10) Pub. No.: US 2019/0028678 A1
(43) Pub. Date: Jan. 24, 2019

(54) SCREEN, PROJECTION SYSTEM AND FOCUSING METHOD

(71) Applicant: BOE TECHNOLOGY GROUP CO., LTD., Beijing (CN)

(72) Inventors: Tailiang LI, Beijing (CN); Hongtao GUAN, Beijing (CN); Wenchu DONG, Beijing (CN); Ying ZHANG, Beijing (CN); Junwei YAN, Beijing (CN)

(21) Appl. No.: 15/963,343

(22) Filed: Apr. 26, 2018

(30) Foreign Application Priority Data
Jul. 20, 2017 (CN) 201710596905.3

(51) Int. Cl. H04N 9/31; G09G 3/00

(52) U.S. Cl. CPC H04N 9/317; G09G 3/001; G06T 7/90; H04N 9/3194; H04N 9/3182

(57) ABSTRACT

A screen, a projection system and a focusing method are provided. The screen is used for presenting a projected image and it includes a screen body, a photosensitive detector and a processor. The photosensitive detector is on a projection surface of the screen body for collecting a gray level of the image presented on the screen body. The processor is for obtaining description information of the image according to the gray level of the image collected by the photosensitive detector, the description information of the image indicating definition of the projected image.

### CROSS REFERENCE TO RELATED APPLICATION

This application claims priority to the patent application No. 201710596905.3 filed with the Patent Office of the People's Republic of China on Jul. 20, 2017, the disclosure of which is incorporated herein by reference.

### TECHNICAL FIELD

The present disclosure relates to the technical field of projection, in particular to a screen, a projection system and a focusing method.

### BACKGROUND

A projection system typically includes a device for projecting pictures, texts or videos onto a screen. The projection system presents images mainly through an “optical engine”. A projector in the existing projection system generally includes a camera, which captures images projected on the screen to obtain definition of the images so as to adjust the focal length of the lens of the projector. Since the camera is disposed on the projector, the camera's capturing images may be influenced by the position of the projector. As the position of the projector changes, the camera needs to be focused accordingly in order to obtain accurate definition of the images. Thus the process of focusing for the projection system is very tedious.

### SUMMARY

Embodiments of the present disclosure provide a screen, a projection system and a focusing method to facilitate focusing of the projection system.

The screen provided in an embodiment of the disclosure comprises a screen body, a photosensitive detector and a processor, the photosensitive detector is located on a projection surface of the screen body for collecting a gray level of the image presented on the screen body, the processor is coupled to the photosensitive detector for obtaining description information of the image based on the gray level of the image collected by the photosensitive detector, the description information indicating definition of the images presented on the screen body.

In some embodiments, the description information includes a focal length evaluation function based on a gray level difference.

In some embodiments, the focal length evaluation function is expressed as:

$$F ( i ) = {\sum }_{( x , y )}^{ } \{ \vert {f}_{i} ( x , y ) - {f}_{i} ( x , y - 1 ) \vert + \vert {f}_{i} ( x , y ) - {f}_{i} ( x - 1 , y ) \vert \} , F ( i )$$

represents the focal length evaluation function, (x, y), (x, y−1) and (x−1, y) are coordinates of pixel points of the image; ƒ(x, y), ƒ(x, y−1) and ƒ(x−1, y) are gray levels of the pixel points of the image collected by the photosensitive detector, and i is a number for a frame of image.

In some embodiments, the screen further comprises a first transmission module for transmitting the description information obtained by the processor.

In some embodiments, the photosensitive detector covers a geometric center of the screen body.

Another embodiment of the present disclosure provides a projection system, which comprises the screen as described in any one of the above embodiments and a projection device, the projection device comprises an optical engine for projecting an image onto the screen body, and a controller for adjusting a distance between a light exit surface of the optical engine and the projection surface of the screen body according to the description information obtained by the processor, thereby adjusting definition of the image presented on the projection surface of the screen body.

In some embodiments, at least one photosensitive detector is within a minimum projection range of the projection device.

In some embodiments, the description information includes a focal length evaluation function based on a gray level difference. The controller is used for controlling the optical engine to move towards or away from the projection surface of the screen body, a distance of each moving of the optical engine being a pre-set step length, and comparing values of focal length evaluation functions of images projected by the optical engine onto the screen body at a starting position and an end position of each moving when the optical engine moves towards or away from the projection surface of the screen body, wherein pixels points of the image within a detection range of the photosensitive detection module have different gray levels.

In some embodiments, if a value of the focal length evaluation function of a projected image corresponding to a starting position of a first moving of the optical engine is smaller than a value of the focal length evaluation function of a projected image corresponding to an end position of the first moving, then the controller controls the optical engine to continue moving the pre-set step length towards a same direction until a value of the focal length evaluation function of a projected image corresponding to a starting position of a certain moving is greater than a value of the focal length evaluation function of a projected image corresponding to an end position of the certain moving, and the starting position of the certain moving is determined as a position where the optical engine stands to get the projected image clearest. If the value of the focal length evaluation function of the projected image corresponding to the starting position of the first moving of the optical engine is greater than the value of the focal length evaluation function of the projected image corresponding to the end position of the first moving, then the controller controls the optical engine to move the pre-set step length towards an opposite direction, until a value of the focal length evaluation function of a projected image corresponding to a starting position of a moving is greater than a value of the focal length evaluation function of a projected image corresponding to an end position of the moving, and the starting position of the moving is determined as a position where the optical engine stands to get the projected image clearest.

In some embodiments, the projection device further comprises at least one motor, which rotates a pre-set angle towards a first direction or a second direction under control of the controller, so as to drive the optical engine to move towards or away from the projection surface of the screen body. The pre-set angle matches the pre-set step length, and the first direction is opposite to the second direction.

In some embodiment, the pre-set angle is 1/200˜1/100 degree.

In some embodiments, the projection device further comprises a second transmission module, for receiving the description information from the processor of the screen and transmitting the description information to the controller.

Still another embodiment of the present disclosure provides a focusing method for the projection system as described in the above embodiments. The focusing method comprises projecting an image by the optical engine onto the screen body, collecting, by the photosensitive detector, a gray level of the image projected by the optical engine onto the screen body, obtaining the description information of the image by the processor based on the gray level of the image collected by the photosensitive detector, and adjusting, by the controller, the distance between the light exit surface of the optical engine and the projection surface of the screen body according to the description information obtained by the processor, thereby adjusting the definition of the image presented on the screen body.

In some embodiments, the description information includes a focal length evaluation function based on a gray level difference.

In some embodiments, the step of adjusting, by the controller, the distance between the light exit surface of the optical engine and the projection surface of the screen body according to the description information obtained by the processor comprises: controlling the optical engine to move towards or away from the projection surface of the screen body, a distance of each moving being the pre-set step length, comparing values of focal length evaluation functions of the images projected by the optical engine onto the screen body at a starting position and an end position of each moving when the optical engine moves towards or away from the projection surface of the screen body, in response to a value of the focal length evaluation function of a projected image corresponding to a starting position of a first moving of the optical engine being smaller than a value of the focal length evaluation function of a projected image corresponding to an end position of the first moving, controlling the optical engine by the controller to continue moving the pre-set step length towards a same direction until a value of the focal length evaluation function of a projected image corresponding to a starting position of a certain moving is greater than a value of the focal length evaluation function of a projected image corresponding to an end position of the certain moving, and determining the starting position of the certain moving as a position where the optical engine stands to get the projected image clearest; in response to the value of the focal length evaluation function of the projected image corresponding to the starting position of the first moving of the optical engine being greater than the value of the focal length evaluation function of the projected image corresponding to the end position of the first moving, controlling the optical engine by the controller to move the pre-set step length towards an opposite direction, until a value of the focal length evaluation function of a projected image corresponding to a starting position of a moving is greater than a value of the focal length evaluation function of a projected image corresponding to an end position of the moving, and determining the starting position of the moving as the position where the optical engine stands to get the projected image clearest. Pixels points of the image within a detection range of the photosensitive detection module have different gray levels.

### BRIEF DESCRIPTION OF DRAWINGS

In order to describe the technical solutions in the embodiments of the present disclosure more clearly, drawings that are to be used for describing the embodiments of the disclosure will be briefly introduced below, but the drawings described below are merely some of the embodiments of the present invention, and those skilled in the art can obtain other drawings from these drawings without inventive efforts.

FIG. 1 is a structural diagram of a screen according to an embodiment of the disclosure;

FIG. 2 is a structural block diagram of a screen according to an embodiment of the disclosure;

FIG. 3 is a structural block diagram of a screen according to another embodiment of the present disclosure;

FIG. 4 is a structural block diagram of a projection system according to an embodiment of the present disclosure;

FIG. 5 is a structural block diagram of a projection device of a projection system according to an embodiment of the present disclosure;

FIG. 6 is a structural block diagram of a projection device of a projection system according to another embodiment of the present disclosure;

FIG. 7 is a flow chart of a focusing method according to an embodiment of the present disclosure;

FIG. 8 is a flow chart of adjusting definition of a projected image in a focusing method according to an embodiment of the present disclosure.

### DETAILED DESCRIPTION OF EMBODIMENTS

Next, technical solutions of the embodiments of the present disclosure will be described clearly and completely with reference to the drawings. The described embodiments are some, instead of all, of the embodiments of the invention. All other embodiments that can be obtained by those skilled in the art without inventive efforts on the basis of the embodiments of the disclosure shall fall into the protection scope of the invention.

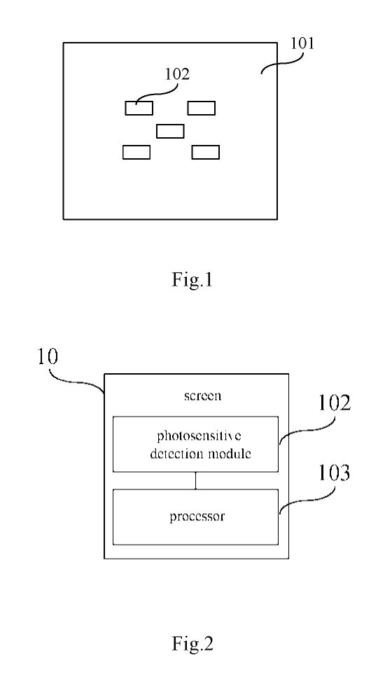

An embodiment of the disclosure provides a screen, which is used for presenting images projected thereon. A projection device may be used for projecting images onto the screen so as to render images on the screen. Specifically, as shown in FIGS. 1 and 2, a screen 10 comprises a screen body 101, a photosensitive detector 102 and a processor 103.

The photosensitive detector 102 may be disposed on a projection surface of the screen body 101 for collecting a gray level of an image projected onto the screen body 101. The “projection surface” herein refers to a surface of the screen body, which is used for showing images projected on the screen body. The photosensitive detector 102 detects an intensity of light irradiated thereon so as to collect the gray level of the image. For example, a higher intensity of the light means a higher gray level. The number of the photosensitive detectors 102 on the screen is not limited herein, as long as the photosensitive detectors 102 can detect light of the images from the projection device like an optical engine and to be displayed on the screen.

The processor 103 is used for obtaining description information of the image according to the gray level of the image collected by the photosensitive detector 102. The description information of the image represents a definition of the projected image. The definition is an important index for indicating the imaging quality of projection. The higher the definition is, the better the quality of imaging.

Therefore, the photosensitive detector 102 is provided on the screen body 101 for detecting the gray levels of images, and the detection of the gray levels of the images would not be affected by the position of the projection device that cooperates with the screen for projecting. Regardless of the position of the projection device, the photosensitive detector 102 can obtain accurate gray values, and obtain accurate description information of the images accordingly. By means of the screen 10 provided in the embodiment of the disclosure, it is not necessary to provide other image capturing devices like a camera for focusing on the projection device, thus adjustment to such image capturing devices on the projection devices is avoided, and focusing of the projection system becomes simpler.

In an embodiment, the description information may include a focal length evaluation function obtained based on a gray level difference method. The focal length evaluation function can be expressed by the following formula:

$$F ( i ) = {\sum }_{( x , y )}^{ } \{ \vert {f}_{i} ( x , y ) - {f}_{i} ( x , y - 1 ) \vert + \vert {f}_{i} ( x , y ) - {f}_{i} ( x - 1 , y ) \vert \}$$

wherein, F(i) represents the focal length evaluation function, i represents a number for a frame of image, (x, y), (x, y−1) and (x−1, y) are coordinates of pixel points of the image. ƒ(x, y), ƒ(x, y−1) and ƒ(x−1, y) are gray levels of the pixel points collected by the photosensitive detector. The formula means to perform difference calculations of the collected gray levels for the pixel points (x, y), (x, y−1) and (x−1, y), to obtain the focal length evaluation function. When the projected image has the highest definition, the focal length evaluation function has the maximum value. If describing the definition of images with the focal length evaluation function, gray level information of multiple frames of images may be collected, so that the focal length evaluation functions for the multiple frames of images can be compared to determine the frame of image with the highest definition. Therefore, during focusing of the projection device, a lens position of the projection device corresponding to the frame of image with the highest definition can be determined. The total number of frames of images may vary with different focusing processes, for example, i=1, 2, . . . m, the value of m is not limited herein, but it is dependent on specific focusing process.

With the above-mentioned focal length evaluation function, the definition of the image can be evaluated accurately, thus facilitating focusing of the projection device in coordination with the screen 10.

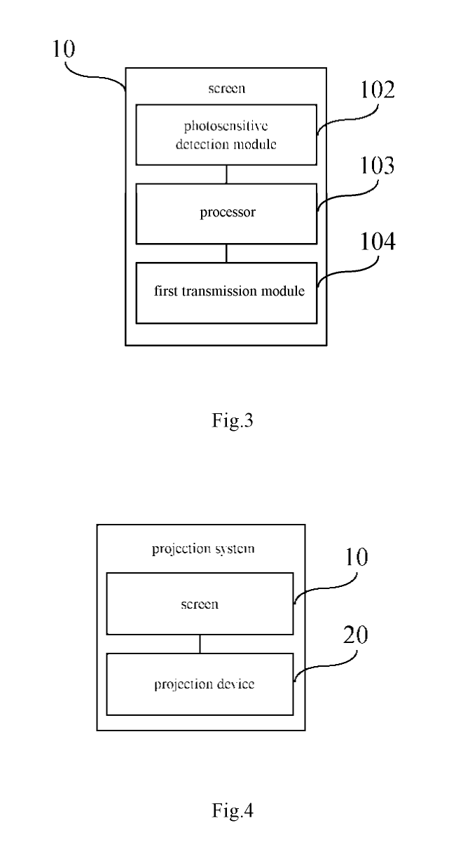

In an embodiment, as shown in FIG. 3, the screen 10 further comprises a first transmission module 104. The first transmission module 104 is coupled to the processor 103 for transmitting the description information obtained by the processor 103. As an example, the first transmission module 104 is a wireless transmission module. For example, the first transmission module 104 is a wireless transmission module that can transmit information by means of WIFI, BLE, RFID or Zigbee.

With the first transmission module 104, information transmission between the screen and other devices can be achieved, especially it is enabled the screen transmits the description information to the projection device.

The screen 10 provided in the above embodiments of the present disclosure has the photosensitive detector 102 arranged on the screen body, the photosensitive detector 102 can detect gray levels of images projected onto the screen, and detection of the gray levels of the images would not be affected by the position or orientation of the projection device that cooperates with the screen 10, so accurate gray levels can be collected; besides, the processor 103 can obtain the description information from the collected gray levels so as to determine the definition of the images on the screen body 101. When the screen 10 is used in cooperation with the projection device, focusing of the projection device becomes simpler.

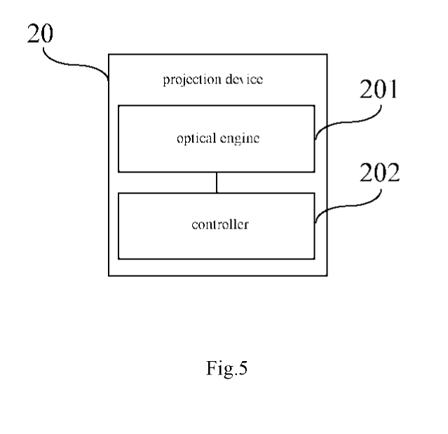

Another embodiment of the present disclosure discloses a projection system. As shown in FIG. 4, the projection system comprises the screen 10 as described in the above embodiments and a projection device 20. Specifically, as shown in FIG. 5, the projection device comprises an optical engine 201 and a controller 202.

The optical engine 201 is used for projecting images onto the screen body 101. The controller 202 is used for adjusting a distance between a light exit surface of the optical engine 201 and a projection surface of the screen body 101 according to the description information obtained by the processor 103, thereby adjusting the definition of the images projected.

With respect to the projection system, the optical engine 201 can project images onto the screen body 101, the photosensitive detector 102 arranged on the screen body 101 can detect the gray levels of the images rendered by projection, the gray level detection of the images is not affected by the position and orientation of the projection device 20, and accurate gray values can be obtained regardless of the position of the projection device 20, thus accurate description information of the images can be obtained. The controller 202 can adjust the distance between the light exit surface of the optical engine 201 and the projection surface of the screen body 101 according to the description information. Therefore, in order to focus the projection system, the projection device does not need to have other image capturing devices like a camera, so that control and adjustment to such image capturing devices are avoided, thus the focusing process is relatively simple.

In an example, the photosensitive detector 102 is arranged within the minimum projection range of the projection device. The range of focal length adjustment of the optical engine is generally limited, when a distance from the optical engine to the screen is smaller than a certain threshold, it is impossible to display clear images on the screen by adjusting the focal length. The “minimum projection range” herein refers to a range of the screen in which a clear image can still be displayed when the focal length of the optical engine has been adjusted to a critical value. For example, if the optical engine cannot render clear images on the screen by adjusting the focal length when the distance from the projection device to the screen is smaller than 50 cm, then the range of the clear image presented on the screen at the time of the projection device having a distance of 50 cm to the screen is defined as the minimum projection range. This embodiment can increase the accuracy of the detected gray levels of the projected images and help to avoid erroneous detection.

In an embodiment, the screen body 101 is a rectangle. The rectangular screen body 101 has a regular shape, which is advantageous to present images of various shapes thereon.

In an embodiment, at least one or some photosensitive detectors 102 cover the geometric center of the screen body 101. The projected images would usually be adjusted to be close to the geometric center of the screen body 101 during projecting, so arranging photosensitive detectors at the geometric center can reduce the risk of failing to detect the gray levels of the projected images.

The controller 202 can control the focusing process of the projection device 20. As in the foregoing described embodiments, the definition of the image can be judged in this embodiment by detecting the gray level, and the description information regarding the projected image includes the focal length evaluation function obtained on the basis of the gray level difference method. As for the details of the focal length evaluation function, it is described in the above embodiments and will not be elaborated herein any more. In an embodiment, the controller 202 can control the optical engine 201 to move towards or away from the projection surface of the screen body 101. The optical engine 201 moves a pre-set step length each time. In the process of focusing, the optical engine 201 projects a frame of image to the screen body 101 each time it moves to a new position, so the controller 202 is further used for comparing values of focal length evaluation functions of the images projected by the optical engine 201 on the screen body 101 at a starting position and an end position of each moving when the optical engine 201 is moving towards or away from the projection surface of the screen body 101. The direction of next moving of the optical engine 201 can be determined based on the result of comparison between the values of the focal length evaluation functions of the projected images corresponding to the starting position and the end position of each moving.

In an embodiment, if the value of the focal length evaluation function of the image projected by the optical engine 201 at a starting position of its first moving is smaller than the value of the focal length evaluation function of the image projected at the end position, then the controller 202 controls the optical engine 201 to continue moving towards the same direction with a pre-set step length, until the value of the focal length evaluation function of the projected image corresponding to a starting position of a certain moving is greater than the value of the focal length evaluation function of the projected image corresponding to a end position of the certain moving, and the starting position of this moving is determined as the position where the optical engine stands to get the projected image clearest.

In another circumstance, if the value of the focal length evaluation function of the image projected by the optical engine 201 at the starting position of the first moving is greater than the value of the focal length evaluation function of the projected image at the end position of the first moving, then the controller 202 controls the optical engine 201 to move towards an opposite direction with a pre-set step length, until a value of the focal length evaluation function of the projected image corresponding to a starting position of a certain moving is greater than a value of the focal length evaluation function of the projected image corresponding to an end position of the certain moving, and the starting position of this certain moving is determined as the position where the optical engine stands to get the projected image clearest.

In the embodiments, the pre-set step length can be a very small value, thus in the process of moving, the optical engine 201 will not move a large distance each time to miss the position where the projected image is the clearest.

Therefore, in the embodiments of the present disclosure, the controller 202 can use a “hill climbing method” for focusing to accurately obtain the clearest frame of image, thereby determining the position of the optical engine 201 corresponding to the clearest image and finishing the focusing.

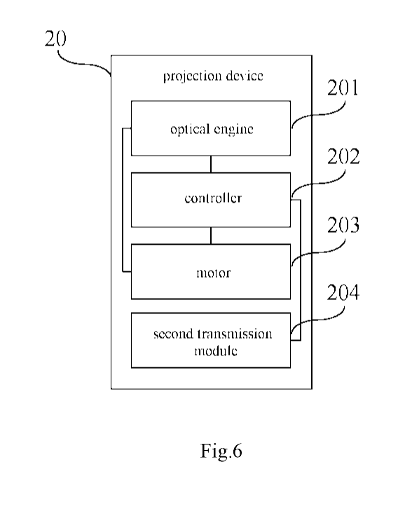

In an embodiment, as shown in FIG. 6, the projection device 20 further comprises at least one motor 203. The motor 203 rotates a pre-set angle towards a first direction or a second direction according to the pre-set step length under the control of the controller 202, so as to drive the optical engine 201 to move towards or away from the projection surface of the screen body 101. The first direction is opposite to the second direction. For example, the first direction is a clockwise direction, and the second direction is a counter-clockwise direction.

The pre-set angle matches the pre-set step length, i.e. the motor rotates a pre-set angle, and the optical engine 201 moves a pre-set step length. In an example, the pre-set angle is 1/200˜1/100 degree. The pre-set angle is small, so the optical engine 201 only moves a very small distance each time so that it will not miss the position for rendering the clearest image.

In the above embodiment, the motor 203 rotates the pre-set angle to drive the optical engine 201 to move the pre-set step length, thus the optical engine 201 can project images onto the screen body 101 at different positions, so that the optimal position of the optical engine 201 can be obtained according to the definitions of the images projected at different positions.

In an embodiment, as shown in FIG. 6, the projection device 20 further comprises a second transmission module 204. The second transmission module 204 is used for receiving the description information (e.g. focal length evaluation function) from the processor of the screen 10, and transmitting the description information to the controller 202, so that the controller 202 can control rotation of the motor according to the description information. The second transmission module 204 can communicate with the first transmission module 104 on the screen so as to receive description information therefrom. The second transmission module 204 can be a wireless transmission module. For example, the second transmission module 204 is a wireless transmission module that can transmit information by means of WIFI, BLE, RFID or Zigbee.

With the second transmission module 204, information transmission between the screen 10 and the projection device 20 can be achieved, especially the above-mentioned description information.

The screen 10 in the projection system provided in the embodiment of the disclosure has a photosensitive detector 102 for detecting gray levels of images presented on the screen. Since the photosensitive detector 102 is arranged on the screen body 101, detection of information of the images presented on the screen will not be affected by the position or orientation of the projection device 20, so accurate gray levels of the images can be collected. Besides, the processor 103 can obtain the description information indicating the definition of the presented images from the collected gray levels, thereby determining the definition of the images on the screen body 101 through the description information. In addition, the controller 202 in the projection device of the projection system controls the movement of the optical engine using the “hill climbing method” according to the received description information, i.e. it gradually adjusts the distance between the light exit surface of the optical engine 201 and the projection surface of the screen body 101 according to the description information so as to obtain an ideal position of the optical engine 201, thus the focusing process is simple.

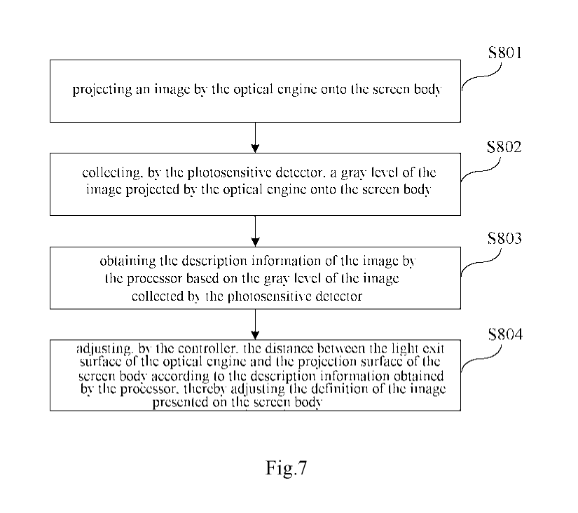

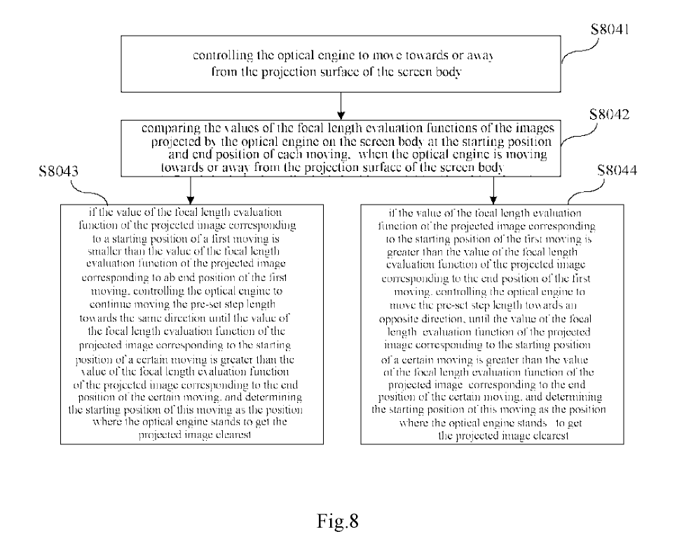

Still another embodiment of the present disclosure discloses a focusing method which is used for the projection system provided in the above embodiments. Specifically, as shown in FIG. 7, the focusing method includes the following steps: step S801, projecting an image by the optical engine to the screen body; step S802: collecting, by the photosensitive detector, a gray level of the image projected by the optical engine on the screen body; step S803: obtaining the description information of the image by the processor according to the gray level of the image collected by the photosensitive detector; step S804: adjusting, by the controller, the distance between the light exit surface of the optical engine and the projection surface of the screen body according to the description information obtained by the processor, thereby adjusting the definition of the image presented on the screen body.

In the embodiment of the present disclosure, the description information includes the focal length evaluation function obtained on the basis of the gray level difference method. As for the focal length evaluation function, it is described in the above embodiments and will not be elaborated herein any more.

By means of the above steps, the gray levels of the images presented can be obtained using the photosensitive detector on the screen body, and detection of the image information will not be affected by the position or orientation of the projection device, so the focusing process becomes simple.

Step S804 can be specifically performed by the “hill climbing method”. As shown in FIG. 8, step S804 includes the following steps.

Step S8041: controlling the optical engine to move towards or away from the projection surface of the screen body. The distance of each moving is the pre-set step length. The pre-set step length can be a very small value, thus in the process of moving, the optical engine will not move a large distance each time to miss the position where the projected image is the clearest.

Step S8042: when the optical engine moves towards or away from the projection surface of the screen body, comparing the values of the focal length evaluation functions of the images projected by the optical engine on the screen body at a starting position and an end position of each moving.

Step S8043: if the value of the focal length evaluation function of the projected image corresponding to a starting position of a first moving is smaller than the value of the focal length evaluation function of the projected image corresponding to ab end position of the first moving, controlling the optical engine to continue moving the pre-set step length towards the same direction until the value of the focal length evaluation function of the projected image corresponding to the starting position of a certain moving is greater than the value of the focal length evaluation function of the projected image corresponding to the end position of the certain moving, and determining the starting position of this moving as the position where the optical engine stands to get the projected image clearest.

Step S8044: if the value of the focal length evaluation function of the projected image corresponding to the starting position of the first moving is greater than the value of the focal length evaluation function of the projected image corresponding to the end position of the first moving, controlling the optical engine to move the pre-set step length towards an opposite direction, until the value of the focal length evaluation function of the projected image corresponding to the starting position of a certain moving is greater than the value of the focal length evaluation function of the projected image corresponding to the end position of the certain moving, and determining the starting position of this moving as the position where the optical engine stands to get the projected image clearest.

In the embodiment, the pixel points of the images within the detection range of the photosensitive detection module have different gray levels, so that the focal length evaluation function can be obtained according to the different gray levels.

In the embodiment of focusing method of the present disclosure, the focusing is performed by a method similar to “hill climbing”, so that the maximum value of the focal length evaluation function can be obtained so as to accurately find the optimal position for projection. In addition, by using the photosensitive detector arranged on the screen body to detect the gray levels of the projected images, detection of the gray levels of the images will not be affected by the position or orientation of the projection device, thus the projection device can obtain the accurate gray levels so as to obtain accurate description information of the images. Besides, the controller adjusts the distance between the light exit surface of the optical engine and the projection surface of the screen body according to the description information so as to obtain the position of the optical engine corresponding to the image with the highest definition, thus the focusing process becomes simpler.

The embodiments in this specification are described in a progressive manner, later embodiments highlight the differences from the former ones, and the same or similar contents of respective embodiments can be cross-referenced.

Although some embodiments of the invention have been described, those skilled in the art can change or modify these embodiments once getting the basic inventive concept disclosed herein. Therefore, the appended claims intend to include these embodiments as well as all alternatives and modifications to these embodiments that fall into the scope of the claims.

In the claims and specification, the terms like “first” and “second” are only used to differentiate one entity or operation from another entity or operation, but they do not necessarily require or suggest that these entities or operations actually have such kind of relation or sequence. The term “include”, “comprise” or any variant thereof has a non-exclusive meaning, that is, a process, method, article or device including a series of elements include not only these elements but also other elements that are not listed explicitly or elements that are inherent to such process, method, article or device. Unless otherwise defined, an element defined by the wording “comprising . . . ” does not mean to exclude the existence of additional same elements in the process, method, article or device comprising the element.

The above described are merely some embodiments of the invention, but the protection scope of the invention is not limited to these embodiments. Any modifications or replacements that can be easily conceived by those skilled in the art within the technical scope disclosed in the invention shall fall into the scope of the invention. Therefore, the protection scope of the invention shall be defined by the claims.

1. A screen for presenting a projected image, comprising a screen body, a photosensitive detector and a processor,
wherein the photosensitive detector is located on a projection surface of the screen body, for collecting a gray level of the image presented on the screen body;
wherein the processor is coupled to the photosensitive detector for obtaining description information of the image based on the gray level of the image collected by the photosensitive detector, the description information indicating definition of the image presented on the screen body.

2. The screen according to claim 1, wherein the description information includes a focal length evaluation function based on a gray level difference.

3. The screen according to claim 2, wherein the focal length evaluation function is expressed as:
$$F ( i ) = {\sum }_{( x , y )}^{ } \{ \vert {f}_{i} ( x , y ) - {f}_{i} ( x , y - 1 ) \vert + \vert {f}_{i} ( x , y ) - {f}_{i} ( x - 1 , y ) \vert \}$$
wherein, F(i) represents the focal length evaluation function, (x, y), (x, y−1) and (x−1, y) are coordinates of pixel points of the image; ƒ(x, y), ƒ(x, y−1) and ƒ(x−1, y) are gray levels of the pixel points of the image collected by the photosensitive detector, and i is a number for a frame of image.

4. The screen according to claim 1, further comprising a first transmission module for transmitting the description information obtained by the processor.

5. The screen according to claim 1, wherein the photosensitive detector covers a geometric center of the screen body.

6. A projection system comprising the screen according to claim 1 and a projection device,
wherein the projection device comprises an optical engine for projecting an image onto the screen body, and
a controller for adjusting a distance between a light exit surface of the optical engine and the projection surface of the screen body according to the description information obtained by the processor, thereby adjusting definition of the image presented on the projection surface of the screen body.

7. The projection system according to claim 6, wherein at least one photosensitive detector is within a minimum projection range of the projection device.

8. The projection system according to claim 6, wherein the description information includes a focal length evaluation function based on a gray level difference,
wherein the controller is used for controlling the optical engine to move towards or away from the projection surface of the screen body, a distance of each moving of the optical engine being a pre-set step length, and
comparing values of focal length evaluation functions of images projected by the optical engine onto the screen body at a starting position and an end position of each moving when the optical engine moves towards or away from the projection surface of the screen body, wherein pixels points of the image within a detection range of the photosensitive detection module have different gray levels.

9. The projection system according to claim 8, wherein if a value of the focal length evaluation function of a projected image corresponding to a starting position of a first moving of the optical engine is smaller than a value of the focal length evaluation function of a projected image corresponding to an end position of the first moving, then the controller controls the optical engine to continue moving the pre-set step length towards a same direction until a value of the focal length evaluation function of a projected image corresponding to a starting position of a certain moving is greater than a value of the focal length evaluation function of a projected image corresponding to an end position of the certain moving, and the starting position of the certain moving is determined as a position where the optical engine stands to get the projected image clearest,
if the value of the focal length evaluation function of the projected image corresponding to the starting position of the first moving of the optical engine is greater than the value of the focal length evaluation function of the projected image corresponding to the end position of the first moving, then the controller controls the optical engine to move the pre-set step length towards an opposite direction, until a value of the focal length evaluation function of a projected image corresponding to a starting position of a moving is greater than a value of the focal length evaluation function of a projected image corresponding to an end position of the moving, and the starting position of the moving is determined as a position where the optical engine stands to get the projected image clearest.

10. The projection system according to claim 8, wherein the projection device further comprises at least one motor, which rotates a pre-set angle towards a first direction or a second direction under control of the controller, so as to drive the optical engine to move towards or away from the projection surface of the screen body,
wherein the pre-set angle matches the pre-set step length, and the first direction is opposite to the second direction.

11. The projection system according to claim 10, wherein the pre-set angle is 1/200˜1/100 degree.

12. The projection system according to claim 6, wherein the projection device further comprises a second transmission module, for receiving the description information from the processor of the screen and transmitting the description information to the controller.

13. A focusing method for the projection system of claim 6, the focusing method comprising:
projecting an image by the optical engine onto the screen body,
collecting, by the photosensitive detector, a gray level of the image projected by the optical engine onto the screen body,
obtaining the description information of the image by the processor based on the gray level of the image collected by the photosensitive detector;
adjusting, by the controller, the distance between the light exit surface of the optical engine and the projection surface of the screen body according to the description information obtained by the processor, thereby adjusting the definition of the image presented on the screen body.

14. The method according to claim 13, wherein the description information includes a focal length evaluation function based on a gray level difference.

15. The method according to claim 14, wherein the step of adjusting, by the controller, the distance between the light exit surface of the optical engine and the projection surface of the screen body according to the description information obtained by the processor comprises:
controlling the optical engine to move towards or away from the projection surface of the screen body, a distance of each moving being the pre-set step length,
comparing values of focal length evaluation functions of the images projected by the optical engine onto the screen body at a starting position and an end position of each moving when the optical engine moves towards or away from the projection surface of the screen body,
in response to a value of the focal length evaluation function of a projected image corresponding to a starting position of a first moving of the optical engine being smaller than a value of the focal length evaluation function of a projected image corresponding to an end position of the first moving, controlling the optical engine by the controller to continue moving the pre-set step length towards a same direction until a value of the focal length evaluation function of a projected image corresponding to a starting position of a certain moving is greater than a value of the focal length evaluation function of a projected image corresponding to an end position of the certain moving, and determining the starting position of the certain moving as a position where the optical engine stands to get the projected image clearest,
in response to the value of the focal length evaluation function of the projected image corresponding to the starting position of the first moving of the optical engine being greater than the value of the focal length evaluation function of the projected image corresponding to the end position of the first moving, controlling the optical engine by the controller to move the pre-set step length towards an opposite direction, until a value of the focal length evaluation function of a projected image corresponding to a starting position of a moving is greater than a value of the focal length evaluation function of a projected image corresponding to an end position of the moving, and determining the starting position of the moving as the position where the optical engine stands to get the projected image clearest,
wherein pixels points of the image within a detection range of the photosensitive detection module have different gray levels.

16. The projection system according to claim 6, wherein the description information includes a focal length evaluation function based on a gray level difference, wherein the focal length evaluation function is expressed as:
$$F ( i ) = {\sum }_{( x , y )}^{ } \{ \vert {f}_{i} ( x , y ) - {f}_{i} ( x , y - 1 ) \vert + \vert {f}_{i} ( x , y ) - {f}_{i} ( x - 1 , y ) \vert \}$$
wherein, F(i) represents the focal length evaluation function, (x, y), (x, y−1) and (x−1, y) are coordinates of pixel points of the image; ƒ(x, y), ƒ(x, y−1) and ƒ(x−1, y) are gray levels of the pixel points of the image collected by the photosensitive detector, and i is a number for a frame of image.

17. The projection system according to claim 6, wherein the screen further comprises a first transmission module for transmitting the description information obtained by the processor.

18. The projection system according to claim 6, wherein the photosensitive detector covers a geometric center of the screen body.
